(19) United States
(12) Patent Application Publication
(10) Pub. No.: US 2020/0079678 A1
(43) Pub. Date: Mar. 12, 2020

(54) protective glass cutting machine

(71) Applicant: Jianhua Yao, Foshan City (CN)

(72) Inventor: Jianhua Yao, Foshan City (CN)

(21) Appl. No.: 16/687,641

(22) Filed: Nov. 18, 2019

(30) Foreign Application Priority Data
Aug. 9, 2019 (CN) 2019107336694

(51) Int. Cl. C03B 33/06; C03B 33/10; B26D 3/16; B26D 7/10

(52) U.S. Cl. CPC C03B 33/06; B26D 7/10; B26D 3/16; C03B 33/105

(57) ABSTRACT

The invention discloses a protective glass cutting machine, including a cutting body, a cutting cavity is arranged in the cutting body, a conveying device is arranged in the cutting cavity, and the conveying device comprises a vertically symmetric conveying The rotating wheel, the opposite direction of the conveying wheel can drive the glass tube to move to the left for cutting. The invention rotates along the glass tube by the heated cutting knife, and the glass tube is quickly cut, and the glass tube is cut. The left and right sides are respectively provided with an output device and a conveying device to ensure the stability of the glass tube and improve the stability of the glass tube cutting. Secondly, when the glass tube is input to the left, the cutting knife and the glass tube are not abutted by the telescopic device.

### CROSS-REFERENCES TO RELATED APPLICATIONS

The present application claims priority from Chinese application No. 2019107336694 filed on Aug. 9, 2019 which is hereby incorporated by reference in its entirety.

### TECHNICAL FIELD

The invention relates to the technical field of glass cutting, in particular to a protective glass cutting machine.

### BACKGROUND OF THE INVENTION

In the conventional glass tube cutting device, the position of the rotatable cutting knife is fixed, the rotation of the glass tube, the glass tube is cut under the action of the cutting knife, and the side of the glass tube is only input on the cutting process. If there is a fastening structure, the output side of the cutting position is easily deflected by the cutting force, which causes the cutting of the cutting to be uneven, and the cutting speed is low, and secondly, when cutting, due to the glass tube and the cutting When the cutter is kept in abutment state, the cutting blade is likely to scratch the surface of the glass tube when the glass tube is input, thereby causing damage to the glass tube. The present invention clarifies an apparatus that solves the above problems.

### CONTENT OF THE INVENTION

Technical problem: in the conventional glass tube cutting device, the glass tube has poor stability, which causes the cutting force to be easily offset, the cutting efficiency is low, and the separation speed of the cut glass tube is slow.

In order to solve the above problem, the present embodiment designs a protective glass cutting machine, in this embodiment, a protective glass cutting machine, comprising a cutting body, wherein the cutting body is provided with a cutting cavity, the cutting a conveying device is arranged in the cutting cavity, and the conveying device comprises a conveying symmetry wheel which is symmetrical upward and downward, the opposite direction of rotation of the conveying wheel can drive the glass tube to move to the left for cutting, and the power conversion device is arranged on the left side of the conveying device.

The power conversion device is provided with a telescopic device on the upper side thereof, and the telescopic device can control the power conversion device to perform power conversion work, and the left side of the power conversion device is provided with an annular cutting and rotating groove, and the cutting and turning a slot is communicated with the cutting cavity, and a cutting device is disposed in the cutting rotary groove, and the cutting device is powerably connected to the power conversion device, and the power conversion device can be the conveying device respectively And the cutting device provides power, the cutting device includes a cutting blade and a heat conducting block, and the cutting device works to drive the cutting blade to rotate around the glass tube, and the heat conducting block driving the cutting knife Accelerating the cutting of the glass tube, the cutting chamber is provided with an output chamber on the left side, an output device is arranged on the outer circumference of the output chamber, and a vibration device is arranged on the rear side of the output device, and the vibration device can The glass tube is clamped, and after the glass tube is cut, it is moved to the left, and then the cut glass tube is output through the output chamber.

Wherein, the conveying device comprises a vertically symmetrical lifting chamber, the lifting chamber is in communication with the cutting cavity, a conveying block is slidably disposed in the lifting chamber, and the conveying wheel is rotatably disposed in the conveying block. a conveying rotating shaft is fixed at a center of the conveying runner, an engaging cavity is arranged on an upper side of the conveying rotating wheel, a gear rotating shaft is arranged in a rotating end wall of the engaging cavity, and a gear rotating shaft is arranged between the gear rotating shaft and the conveying rotating shaft a first bevel gear is fixed to the front end of the gear shaft, and a second bevel gear is meshed on the upper side of the first bevel gear, and a spline shaft is fixed at the center of the second bevel gear. a telescopic spring is sleeved on the spline shaft, and a spline sleeve is arranged in the upper end wall of the lifting chamber, and the spline sleeve is powered by a transmission belt, and the rear side of the lifting chamber is rotated to provide a connection. a shaft, the upper and lower ends of the connecting shaft are respectively connected to the driving belt, so that the conveying block can drive the conveying wheel to perform telescopic adjustment according to the outer diameter of the glass tube, so that the conveying wheel and the conveying wheel The glass tube abuts The upper and lower conveyance of the glass tube can drive the rotation of the wheel to the left.

The power conversion device includes a conversion cavity, a conversion block is slidably disposed in the conversion cavity, and an abutting block is fixed on an upper end surface of the conversion block, and a return spring is disposed on the outer periphery of the abutting block, and the resetting is performed. The upper and lower ends of the spring are respectively fixedly connected to the upper end wall of the conversion cavity and the upper end surface of the conversion block, wherein the conversion block is provided with a power motor, and the lower end of the power motor is powered by a power rotating shaft, and the power shaft is fixed on the power shaft. a driving gear, a third bevel gear is fixed on a lower side of the driving gear, a fourth bevel gear is meshably coupled to a left end of the third bevel gear, and the fourth bevel gear is dynamically connected to the cutting device, a driven rotating groove is disposed in a right end wall of the conversion chamber, and a driven gear is disposed in the driven rotating groove, wherein the driven gear is meshed with the driving gear, and the driven gear is fixed at a center thereof a driven rotating shaft, wherein the upper side of the driven rotating groove is provided with a belt groove, the upper end of the driven rotating shaft is rotatably connected with the upper end wall of the belt groove, and the spline sleeve of the upper side penetrates the belt groove, Said spline sleeve in the belt groove The driven shaft is connected by a power belt, wherein the power motor supplies power to the conveying device when the driving gear meshes with the driven gear, and the third bevel gear and the fourth bevel gear The power motor provides power to the cutting device when engaged.

The telescopic device includes an annular telescopic groove, and a telescopic motor is fixed to the right end wall of the telescopic slot. The left end of the telescopic motor is mounted with a push rod, and the push rod is provided with an abutting groove, and the abutting block is provided. The upper end protrudes into the telescopic groove and abuts against the abutting groove, the left end of the push rod is fixed with an annular plate, and the left end of the annular plate is a bevel structure, so that the telescopic motor can work to make the push rod Moving to the left, the abutment block is lowered to control the power conversion of the power motor.

Wherein the cutting device includes an annular groove, the annular groove is in communication with the right side of the cutting rotary groove, the ring groove is rotated to be provided with a ring gear, and the ring gear is internally meshed with a rotating gear. A rotating rod is fixed at a center of the rotating gear, and a right end of the rotating rod is fixedly connected to the fourth bevel gear, and a cutting rotary block is disposed in the cutting rotary groove, and a right end surface of the cutting rotating block is disposed There is a pressing groove, a pressing slider is slidably disposed in the pressing groove, and a pressing spring is fixed between the upper end of the pressing block and the pressing groove, and the right end of the pressing block is The toothed ring is fixedly connected, the adjusting rotary block is provided with an adjusting cavity, the adjusting cavity is slidably provided with a mounting block, the heat conducting block is installed in the mounting block, and the heat conducting block is externally powered Electrically connected, an adjusting chute is disposed in the left end wall of the adjusting chamber, and an adjusting screw is disposed in the adjusting chute, and the mounting block is screwed to the adjusting screw, and the cutting chute is The outer side of the adjusting screw is provided with an annular groove, and the upper end of the adjusting screw extends into the groove and the adjusting rotating block is fixed The upper end surface of the cutting block is fixed with a solid block, and the solid block is sleeved with a pressure spring, the upper end of the solid block extends into the telescopic groove, and the right end surface of the solid block is a bevel structure. Abutting with the annular plate, thereby rotating the adjusting knob to adjust the position of the mounting block, so that the cutting blade abuts the glass tube.

The output device includes a moving cavity, a driving motor is fixed in a right end wall of the moving cavity, a rotating screw is mounted on a left end of the driving motor, and a left end of the rotating screw is rotatably connected to a left end wall of the moving cavity. a sliding block is disposed in the moving cavity, a lower end surface of the moving block is a toothed structure, a front end of the moving block is fixed with a connecting spring, and a sliding slot is disposed in the moving block. a sliding block is arranged in the sliding slot, the sliding block is screwed to the rotating screw, a winding chamber is arranged on the upper side of the sliding slot, and a winding wheel is arranged in the winding cavity. Two winding ropes are fixedly disposed on the winding reel, the pulling ropes are arranged in front and rear, and the upper end wall of the winding chamber is fixed with a rotating motor, and the winding wheel is dynamically connected with the rotating motor, The moving block is provided with a front and rear symmetrical clamping cavity, the clamping cavity is in communication with the output cavity, and a tensioning wheel is arranged between the clamping cavity and the winding cavity, and the lower end of the pulling rope is wound Opening the tensioning wheel and extending into the clamping cavity, the clamping cavity a clamping slide is fixed, the drawstring is fixedly connected to the clamping slide rod, and a clamping spring is fixed on an end surface of the clamping slide away from the output cavity, and the clamping sliding rod is close to a clamping block is fixed at one end of the symmetry center, and an anti-slip pad is fixed to an end surface of the clamping block near the center of symmetry, thereby clamping the glass tube through the clamping block, and after cutting the result, the The driving motor operates to move the moving block to the left, so that the glass tube moves to the left, and when the clamping block is moved away from each other, the glass tube is output through the output chamber.

Wherein, the vibration device comprises a transmission slot, the upper side of the transmission slot is in communication with the movement cavity, the transmission slot is internally provided with a transmission gear, and the transmission gear meshes with the moving block, the transmission gear center A drive shaft is fixedly disposed, and a rearward side of the transmission slot is disposed with a reversing cavity, and a rear end of the transmission shaft extends into the reversing cavity and is fixed with a fifth bevel gear, and the fifth bevel gear is a sixth bevel gear is coupled to the end of the sixth bevel gear, and a reversing shaft is fixed at a center of the sixth bevel gear. The upper side of the reversing cavity is provided with a cam cavity, and the upper end of the reversing shaft and the upper end wall of the cam cavity Rotating the connection, a cam is fixed on the reversing shaft in the cam cavity, and the cam abuts against a rear end surface of the moving block, so that when the moving block moves to the left, the cam rotates, Then, a small amplitude vibration occurs before and after the moving block to accelerate the separation of the glass tube.

The invention has the beneficial effects that the invention rotates along the glass tube by the heated cutting knife, and the glass tube is quickly cut, and the left and right sides of the cutting position of the glass tube are respectively provided with an output device and a conveying device to ensure the glass tube. The stability of the glass tube improves the stability of the cutting of the glass tube. Secondly, when the glass tube is input to the left, the cutting knife and the glass tube are not abutted by the telescopic device, so that the cutter does not scratch the outer surface of the glass tube, and the cut glass is cut. The tube can increase the separation speed of the cutting position by the vibration device, thereby improving the efficiency of the overall cutting work.

### BRIEF DESCRIPTION OF THE DRAWINGS

For ease of description, the present invention is described in detail by the following specific embodiments and the accompanying drawings.

FIG. 1 is a schematic view showing the overall structure of a protective glass cutting machine of the present invention;

FIG. 2 is an enlarged schematic structural view of “A” of FIG. 1;

FIG. 3 is a schematic structural view long “B-B” direction of FIG. 1;

FIG. 4 is an enlarged schematic view of the structure “C” of FIG. 3;

FIG. 5 is a schematic enlarged view of the “D” of FIG. 1;

FIG. 6 is a schematic enlarged view of the structure “E” of FIG. 5;

FIG. 7 is a schematic view showing the structure along “F-F” direction of FIG. 1;

FIG. 8 is a schematic view showing the structure along “G-G” direction of FIG. 1.

### DETAILED DESCRIPTION OF THE INVENTION

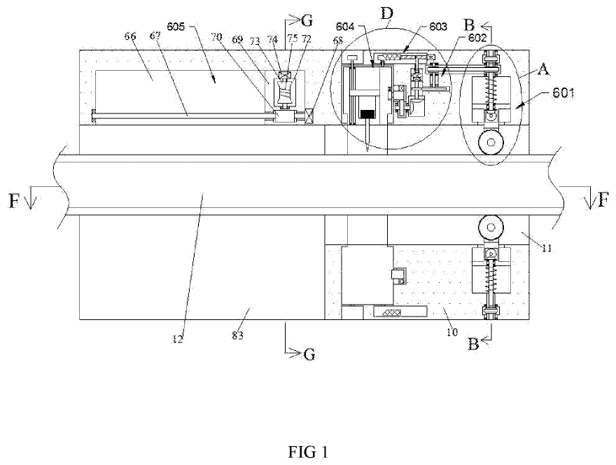

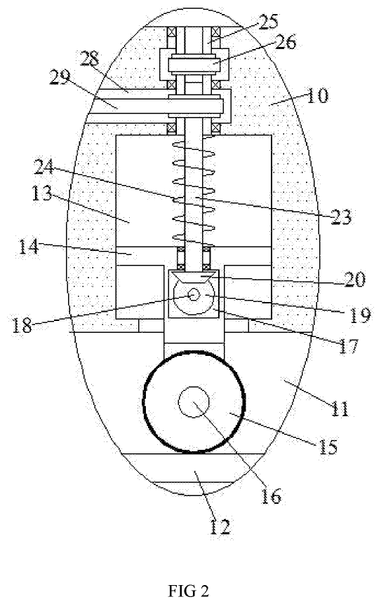

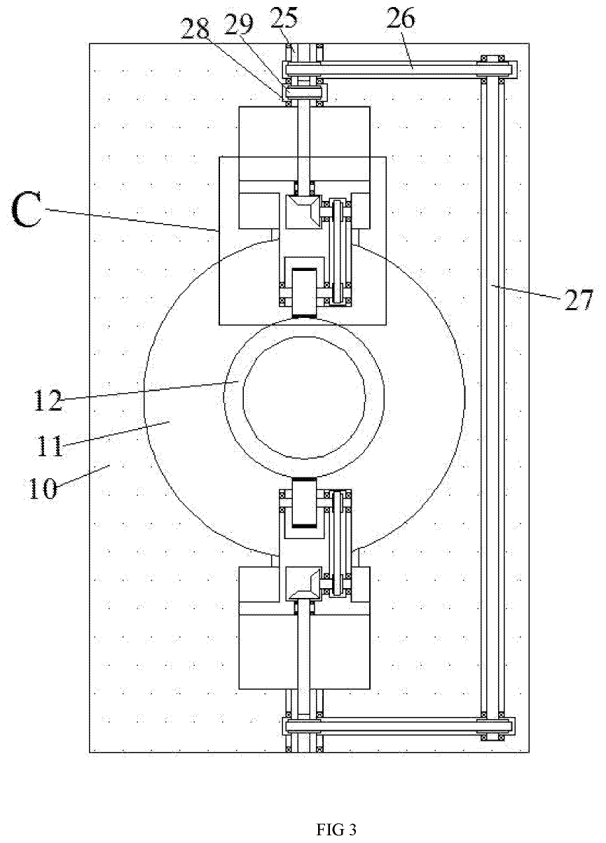

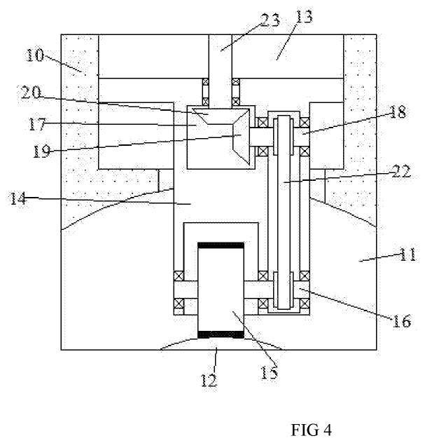

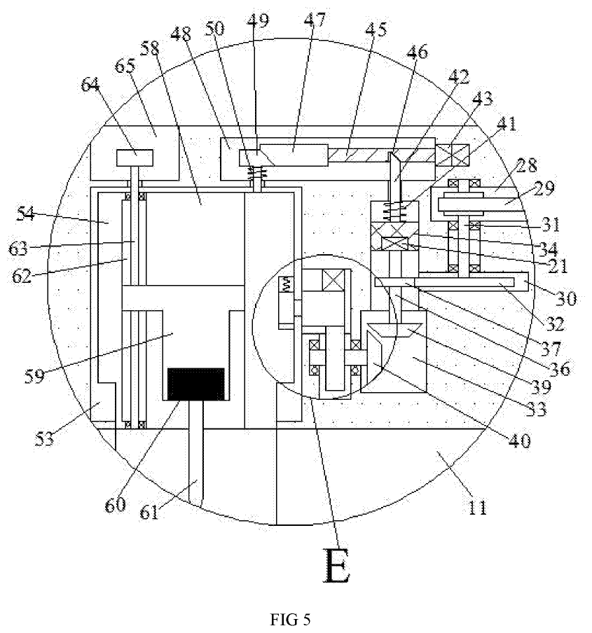

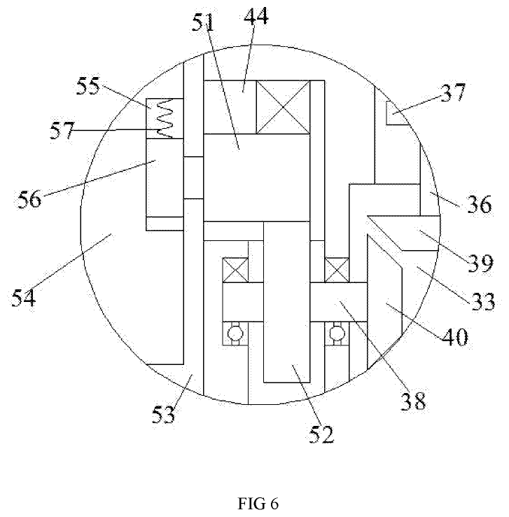

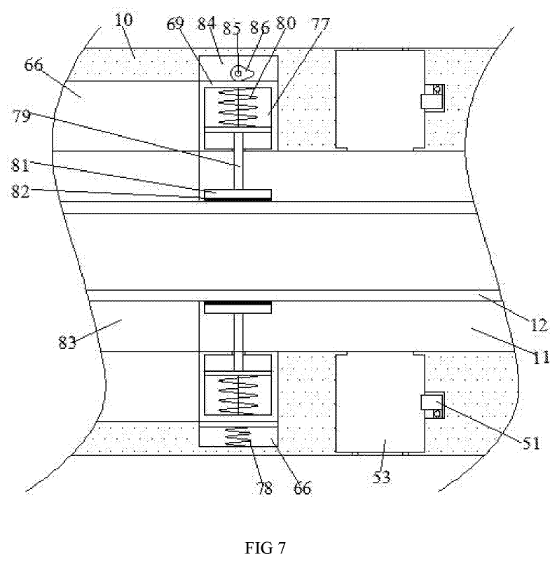

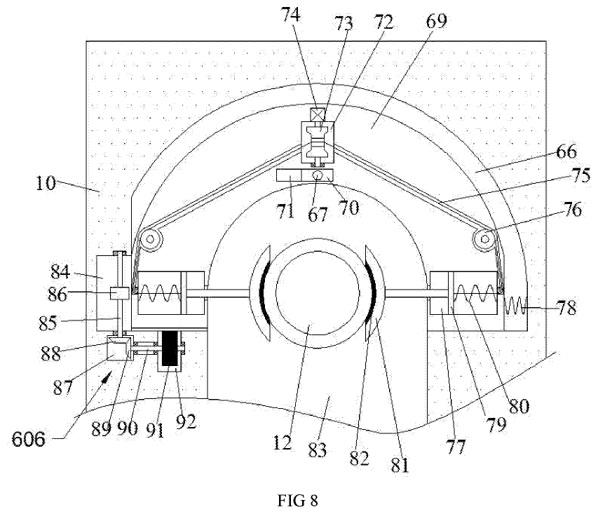

The present invention will now be described in detail with reference to FIGS. 1 to 8.

For the convenience of description, the orientations described below are defined as follows: the up, down, left, and right front and rear directions described below are identical to the up, down, left, and right front and rear directions of the projection relationship of FIG. 1 itself.

The invention relates to a protective glass cutting machine, which is mainly used for cutting work of a glass tube. The present invention will be further described below in conjunction with the drawings of the present invention: a protective glass cutting machine according to the present invention includes a cutting body 10, a cutting cavity 11 is disposed in the cutting body 10, and a conveying device 601 is disposed in the cutting cavity 11, and the conveying The device 601 includes a vertically symmetrical conveying wheel 15, and the conveying wheel 15 is oppositely rotated to drive the glass tube 12 to the left for cutting. The left side of the conveying device 601 is provided with a power conversion device 602. The upper side of the device 602 is provided with a telescopic device 603. The telescopic device 603 can control the power conversion device 602 to perform a power conversion operation. The left side of the power conversion device 602 is provided with an annular cutting and rotating groove 53, and the cutting is performed. The rotary groove 53 communicates with the cutting cavity 11, and the cutting rotary groove 53 is provided with a cutting device 604. The cutting device 604 is electrically connected to the power conversion device 602, and the power conversion device is The 602 can respectively provide power to the conveying device 601 and the cutting device 604. The cutting device 604 includes a cutting blade 61 and a heat conducting block 60. The cutting device 604 can work to drive the cutting. The knife 61 rotates around the glass tube 12, and the heat conducting block 60 belt The cutting blade 61 generates heat to accelerate the cutting of the glass tube 12, the cutting chamber 11 is provided with an output chamber 83 on the left side thereof, and an output device 605 is disposed on the outer circumference of the output chamber 83. The output device 605 is provided. The rear side is provided with a vibration device 606, which can clamp the glass tube 12, and after the glass tube 12 is cut, it is moved to the left, and then the cut glass tube 12 passes. The output chamber 83 is output.

According to the embodiment, the conveying device 601 is described in detail below. The conveying device 601 includes a vertically symmetrical lifting chamber 13, the lifting chamber 13 is in communication with the cutting chamber 11, and the lifting chamber 13 is slidably provided for conveying. The conveying rotor 15 is rotatably disposed in the conveying block 14, the conveying rotating shaft 16 is fixed at the center of the conveying runner 15, and the engaging chamber 17 is disposed on the upper side of the conveying runner 15, a gear rotating shaft 18 is disposed in the rear end wall of the engaging cavity 17, and the gear rotating shaft 18 and the conveying rotating shaft 16 are dynamically connected by a timing belt 22, and the first bevel gear 19 is fixed to the front end of the gear rotating shaft 18, a second bevel gear 20 is coupled to the upper side of the first bevel gear 19, a spline shaft 23 is fixed at a center of the second bevel gear 20, and a telescopic spring 24 is sleeved on the spline shaft 23, A spline sleeve 25 is disposed in the upper end wall of the lifting chamber 13. The spline sleeve 25 is electrically connected to the transmission belt 26, and the connecting shaft 27 is rotated between the rear sides of the lifting chamber 13. The ends are respectively electrically connected to the drive belt 26 so as to be external to the glass tube 12 The conveying block 14 can drive the conveying wheel 15 to perform telescopic adjustment, so that the conveying wheel 15 abuts the glass tube 12, and the upper and lower conveying wheels 15 rotate to drive the glass tube. 12 moves to the left.

According to the embodiment, the power conversion device 602 is described in detail below. The power conversion device 602 includes a conversion cavity 33. The conversion cavity 33 is slidably provided with a conversion block 34, and the upper end surface of the conversion block 34 is fixedly abutted. a block 42 is disposed on the outer periphery of the abutting block 42 with a return spring 41. The upper and lower ends of the return spring 41 are respectively fixed to the upper end wall of the conversion cavity 33 and the upper end surface of the conversion block 34. A power motor 21 is disposed. The lower end of the power motor 21 is powered by a power shaft 36. The power shaft 36 is fixed with a driving gear 37. The lower side of the driving gear 37 is fixed with a third bevel gear 39. The fourth bevel gear 40 is meshed with the fourth bevel gear 40. The fourth bevel gear 40 is electrically connected to the cutting device 604. The right end wall of the conversion cavity 33 is connected with a driven rotary groove 30. The driven gear 30 is rotated and provided with a driven gear 32. The driven gear 32 is meshed with the driving gear 37. A driven rotating shaft 31 is fixed at the center of the driven gear 32. The upper side of the rotating groove 30 is provided with a belt groove 28, and the upper end of the driven rotating shaft 31 is The upper end wall of the belt groove 28 is rotatably connected, and the spline sleeve 25 of the upper side passes through the belt groove 28, and passes between the spline sleeve 25 and the driven shaft 31 in the belt groove 28. The power belt 29 is connected such that when the driving gear 37 meshes with the driven gear 32, the power motor 21 supplies power to the conveying device 601, and the third bevel gear 39 and the fourth bevel gear 40 The power motor 21 provides power to the cutting device 604 when engaged.

According to the embodiment, the telescopic device 603 is described in detail below. The telescopic device 603 includes an annular telescopic groove 48. The right end wall of the telescopic groove 48 is fixed with a telescopic motor 43. The left end of the telescopic motor 43 is mounted with a push rod 45. The push rod 45 is provided with an abutting groove 46. The upper end of the abutting block 42 extends into the telescopic groove 48 and abuts against the abutting groove 46. The left end of the push rod 45 is fixed with a ring. The plate 47 has a beveled structure at the left end of the annular plate 47, so that the telescopic motor 43 can work to move the push rod 45 to the left, and the abutting block 42 is lowered to control the power conversion of the power motor 21.

According to the embodiment, the cutting device 604 is described in detail below. The cutting device 604 includes an annular groove 44, and the annular groove 44 communicates with the right side of the cutting rotary groove 53, and the annular groove 44 is rotated inside. a toothed ring 51 having a rotating gear 52 meshed therein, a rotating rod 38 is fixed at a center of the rotating gear 52, and a right end of the rotating rod 38 is fixedly connected to the fourth bevel gear 40. a cutting and rotating block 54 is disposed in the cutting and rotating groove 53. The cutting end of the cutting and rotating block 54 is provided with a pressing groove 55. The pressing groove 55 is slidably provided with a pressing slider 56. A pressing spring 57 is fixed between the upper end of the pressing slider 56 and the pressing groove 55, and the right end of the pressing slider 56 is fixedly connected to the ring gear 51, and the cutting rotary block 54 is provided therein. There is an adjustment chamber 58 in which a mounting block 59 is slidably disposed. The heat conducting block 60 is mounted in the mounting block 59, and the heat conducting block 60 is electrically connected to the outside world. An adjusting chute 62 is disposed in the left end wall of the 58. The adjusting chute 62 is internally provided with an adjusting screw 63. The mounting block 59 is screwed to the adjusting screw 63. An outer annular groove 65 is defined in the outer side of the cutting rotary groove 53. The upper end of the adjusting screw 63 extends into the groove 65 and is fixed with an adjusting rotating block 64, and the upper end surface of the cutting rotary block 54 A solid block 49 is fixed, and the solid block 49 is sleeved with a compression spring 50. The upper end of the solid block 49 extends into the telescopic groove 48, and the right end surface of the solid block 49 is a sloped structure for The annular plate 47 abuts, so that the adjustment knob 64 is rotated to adjust the position of the mounting block 59 such that the cutting blade 61 abuts against the glass tube 12.

According to the embodiment, the output device 605 is described in detail below. The output device 605 includes a moving cavity 66. A driving motor 68 is fixed in the right end wall of the moving cavity 66, and a rotating screw 67 is mounted on the left end of the driving motor 68. The left end of the rotating screw 67 is rotatably connected to the left end wall of the moving cavity 66. The moving cavity 66 is slidably provided with a moving block 69. The lower end surface of the moving block 69 is a toothed structure, and the front end of the moving block 69 A connecting spring 78 is fixed to the front end wall of the moving chamber 66. The moving block 69 is provided with a sliding slot 71. The sliding slot 71 is slidably provided with a sliding block 70, the sliding block 70 and the rotating wire. The upper end of the sliding groove 71 is provided with a winding chamber 72. The winding chamber 72 is rotated to be provided with a winding wheel 73. The winding wheel 73 is fixedly provided with two pulling ropes 75. The pulling rope 75 is disposed in front and rear, and the upper end wall of the winding chamber 72 is fixed with a rotating motor 74. The winding wheel 73 is dynamically connected with the rotating motor 74, and the moving block 69 is provided with front and rear symmetry. a clamping cavity 77, the clamping cavity 77 is in communication with the output cavity 83, the clamping cavity 77 and the receiving cavity a tensioning wheel 76 is disposed between the winding chambers 72. The lower end of the pulling rope 75 is wound around the tensioning wheel 76 and extends into the clamping cavity 77. The clamping cavity 77 is slidably clamped. a sliding rod 79, the pulling rope 75 is fixedly connected to the clamping slide 79, and a clamping spring 79 is fixed to a side surface of the output cavity 83 to fix a torsion spring 80. A clamping block 81 is fixed to one end of the rod 79 near the center of symmetry, and an anti-slip pad 82 is fixed to an end surface of the clamping block 81 near the center of symmetry, thereby clamping the glass tube 12 through the clamping block 81. After the cutting result, the driving motor 68 operates to move the moving block 69 to the left, so that the glass tube 12 moves to the left, and when the clamping block 81 moves back to each other, the The glass tube 12 is output through the output chamber 83.

According to the embodiment, the vibration device 606 is described in detail below. The vibration device 606 includes a transmission groove 92. The upper side of the transmission groove 92 communicates with the movement chamber 66. The transmission groove 92 is rotated to provide a transmission gear 91. The transmission gear 91 is engaged with the moving block 69. The transmission shaft 90 is fixed at the center of the transmission gear 91. The rear side of the transmission groove 92 is provided with a reversing chamber 87, and the rear end of the transmission shaft 90 And extending into the reversing chamber 87 and fixing a fifth bevel gear 89. The rear end of the fifth bevel gear 89 is meshed with a sixth bevel gear 88, and the sixth bevel gear 88 is fixed at the center. To the rotating shaft 85, the upper side of the reversing chamber 87 is provided with a cam cavity 84, and the upper end of the reversing rotating shaft 85 is rotatably connected with the upper end wall of the cam cavity 84, and the reversing shaft in the cam cavity 84 A cam 86 is fixed on the 85, and the cam 86 abuts against the rear end surface of the moving block 69, so that when the moving block 69 moves to the left, the cam 86 is rotated, and the moving block 69 is small before and after. The vibration of the amplitude accelerates the separation of the glass tube 12.

The steps of using the protective glass cutting machine in the following are described in detail below with reference to FIG. 1 to FIG. 8:

In use, the rotating motor 74 operates to drive the winding reel 73 to rotate, and the pulling rope 75 contracts so that one end of the clamping slider 79 away from the center of symmetry abuts against the inner end wall of the clamping cavity 77, and the clamping blocks 81 move to each other to At the longest distance, the torsion spring 80 is in a compressed state, and the glass tube 12 is placed in the cutting cavity 11 to the left. According to the outer diameter of the glass tube 12, the conveying wheel 15 is moved away from the cutting cavity 11, so that The conveying runner 15 is in contact with the glass tube 12, and the rotating motor 74 is reversely operated, so that the winding reel 73 is reversed, and the clamping slider 79 is close to each other under the elastic restoring force of the torsion spring 80, passing through the clamping block 81. When the glass tube 12 is clamped, the conveying wheel 15 and the clamping block 81 cut the glass tube 12 into two sides to ensure the stability of the cutting, and the power motor 21 operates, so that the driving gear 37 drives the driven gear. 32 rotates, the upper spline sleeve 25 is rotated by the power belt 29, and the connecting shaft 27 drives the lower spline sleeve 25 to rotate, thereby rotating the upper and lower spline shafts 23, and rotating the conveying shaft 16 through the timing belt 22. Then, the conveying wheel 15 rotates to input the glass tube 12 to the left. When the cutting position of the glass tube 12 corresponds to the cutting blade 61, the conveying wheel 15 stops rotating. Thereafter, the telescopic motor 43 operates to move the push rod 45 to the left, and the abutting block 42 descends to drive the conversion block 34 to descend. The driving gear 37 is disengaged from the driven gear 32, and the third bevel gear 39 meshes with the fourth bevel gear 40. When the push rod 45 moves to the left, the solid block 49 is pushed down by the annular plate 47, and the cutting block 54 drives the cutting. The cutter 61 is lowered. Then, the adjusting rotary block 64 is rotated to rotate the adjusting screw 63, and the mounting block 59 is moved toward the cutting chamber 11, so that the cutting blade 61 abuts against the glass tube 12, and the power motor 21 operates. When the fourth bevel gear 40 rotates, the ring gear 51 rotates, the cutting rotary block 54 rotates, and the cutting knife 61 rotates around the glass tube 12, and the heat conducting block 60 energizes and heats the cutting blade 61, thereby improving the cutting blade 61. Cutting efficiency

After the cutting is completed, the telescopic motor 43 is operated to move the push rod 45 to the right, and the abutting block 42 is raised, so that the power motor 21 provides power for the rotation of the driven gear 32. At this time, the annular plate 47 is moved to the right so that the solid block 49 is fixed. The self-love pressure spring 50 rises under the elastic restoring force, and then the cutting rotary block 54 rises, so that the cutting blade 61 is disengaged from the glass tube 12, and the driving motor 68 operates, so that the rotating screw 67 rotates, and the sliding block 70 drives the moving block 69. When moving to the left, the transmission groove 92 rotates to drive the sixth bevel gear 88 to rotate, so that the cam 86 rotates. Under the action of the connecting spring 78, the moving block 69 reciprocates back and forth to generate a small amplitude vibration, so that the glass tube 12 is cut. Separating, when the moving block 69 moves to the left and disengages from the transmission slot 92, the moving block 69 stops vibrating, and the moving block 69 drives the glass tube 12 to continuously move to the left, and the rotating motor 74 works to make the pulling rope 75 when the winding rope 75 is wound. The rods 79 are away from each other, so that the clamping block 81 is loosened, and the glass tube 12 is lowered and outputted through the output chamber 83. Then, the power motor 21 is operated to drive the driven gear 32 to rotate, thereby causing the conveying wheel 15 to rotate to drive the glass. The tube 12 is moved to the left. When the glass tube 12 is moved to the position to be cut and opposed to the cutting blade 61, the rotating motor 74 is reversed so that the clamping blocks 81 are close to each other to clamp the glass tube 12, and the telescopic motor 43 is operated again. The cutting blade 61 is brought into abutment with the glass tube 12, so that the rotation of the cutting blade 61 causes the glass tube 12 to be cut again.

The invention has the beneficial effects that the invention rotates along the glass tube by the heated cutting knife, and the glass tube is quickly cut, and the left and right sides of the cutting position of the glass tube are respectively provided with an output device and a conveying device to ensure the glass tube. The stability of the glass tube improves the stability of the cutting of the glass tube. Secondly, when the glass tube is input to the left, the cutting knife and the glass tube are not abutted by the telescopic device, so that the cutter does not scratch the outer surface of the glass tube, and the cut glass is cut. The tube can increase the separation speed of the cutting position by the vibration device, thereby improving the efficiency of the overall cutting work.

In the above manner, those skilled in the art can make various changes depending on the mode of operation within the scope of the present invention.

1. A protective glass cutting machine comprising a cutting body; the cutting body is provided with a cutting cavity, and the cutting cavity is provided with a conveying device, wherein the conveying device comprises a vertically symmetrical conveying wheel, and the conveying wheel is oppositely rotated to drive the glass tube to the left. For cutting, a power conversion device is disposed on a left side of the conveying device, and a telescopic device is disposed on an upper side of the power conversion device, and the telescopic device can control the power conversion device to perform power conversion work; the left side of the power conversion device is provided with an annular cutting rotary groove, the cutting rotary groove is in communication with the cutting cavity, and the cutting rotary groove is provided with a cutting device, and the cutting device and the cutting device The power conversion device can be powered, and the power conversion device can respectively power the conveying device and the cutting device; the cutting device includes a cutting blade and a heat conducting block, wherein the cutting device works to drive the cutting blade to rotate around the glass tube, and the heat conducting block drives the cutting blade to heat up and accelerate Cutting the glass tube, the left side of the cutting chamber is provided with an output cavity, and the output chamber is provided with an output device; the rear side of the output device is provided with a vibration device, which can clamp the glass tube, and after the glass tube is cut, it is moved to the left, and then the glass tube after cutting is passed through The output cavity output.

2. The protective glass cutting machine according to claim 1, wherein said conveying means comprises a lifting chamber vertically symmetrical; the lifting chamber is in communication with the cutting cavity, the lifting chamber is slidably provided with a conveying block, the conveying wheel is rotatably disposed in the conveying block, and a conveying shaft is fixed at a center of the conveying wheel. An upper surface of the conveying wheel is provided with an engaging cavity, and a rotating shaft is arranged in the rear end wall of the engaging cavity, and the gear rotating shaft and the conveying rotating shaft are connected by a synchronous belt, and the front end of the gear rotating shaft is fixed; the first bevel gear has a second bevel gear coupled to the upper side of the first bevel gear, a spline shaft is fixed at the center of the second bevel gear, and a telescopic spring is sleeved on the spline shaft; a spline sleeve is arranged in the upper end wall of the lifting chamber, the spline sleeve is powered by a transmission belt, and a connecting shaft is arranged between the rear side of the lifting chamber, and the upper and lower ends of the connecting shaft are respectively associated with the Drive belt power connection.

3. The protective glass cutting machine according to claim 1, wherein said power conversion device comprises a conversion chamber; a switching block is disposed in the conversion cavity, and an abutting block is fixed on an upper end surface of the conversion block, and a return spring is disposed on the outer periphery of the abutting block, and upper and lower ends of the return spring and an upper end wall of the conversion cavity respectively And fixing the upper end surface of the conversion block; a power motor is disposed in the conversion block, a power rotating shaft is mounted on the lower end of the power motor, a driving gear is fixed on the power rotating shaft, and a third bevel gear is fixed on the lower side of the driving gear, and the third a fourth bevel gear is meshably coupled to the left end of the bevel gear, and the fourth bevel gear is mechanically coupled to the cutting device; a driven rotating groove is disposed in a right end wall of the conversion chamber, and a driven gear is disposed in the driven rotating groove; the driven gear is meshed with the driving gear, and the driven gear is fixed at a center thereof. with a driven shaft; a belt groove is disposed on the upper side of the driven rotating groove, and an upper end of the driven rotating shaft is rotatably connected to the upper end wall of the belt groove, and the spline sleeve of the upper side penetrates the belt groove in the belt groove The spline sleeve is coupled to the driven shaft by a power belt.

4. The protective glass cutting machine according to claim 1, wherein said telescopic device comprises an annular telescopic groove; a telescopic motor is disposed on a right end wall of the telescopic slot, and a push rod is disposed at a left end of the telescopic motor, and the push rod is provided with an abutting groove, and an upper end of the abutting block extends into the telescopic slot and is Abutting groove abutment; the left end of the push rod is fixed with an annular plate, and the left end of the annular plate is a bevel structure.

5. The protective glass cutting machine according to claim 1, wherein said cutting device comprises an annular groove; the annular groove is in communication with the right side of the cutting rotary groove, the ring groove is rotated and provided with a ring gear, the ring gear is internally meshed with a rotating gear, and a rotating rod is fixed at the center of the rotating gear. The right end of the rotating rod is fixedly connected to the fourth bevel gear, and the cutting rotary groove is slidably disposed in the cutting rotary groove; a pressing groove is disposed in the right end surface of the cutting block, and a pressing slider is slidably disposed in the pressing groove, and a pressing spring is fixed between the upper end of the pressing block and the pressing groove The right end of the pressing slider is fixedly connected to the ring gear, the cutting rotary block is provided with an adjusting cavity, and the adjusting cavity is slidably provided with a mounting block, and the heat conducting block is installed in the mounting block And the heat conducting block is electrically connected to the outside city; an adjusting chute is disposed in the left end wall of the adjusting chamber, and an adjusting screw is disposed in the adjusting chute, the mounting block is screwed to the adjusting screw, and the cutting trough is connected to the outside. An annular groove, an upper end of the adjusting screw extends into the groove and a regulating turn block is fixed.

6. The protective glass cutting machine according to claim 5, wherein the upper end surface of the cutting block is fixed with a solid block; a pressure spring is sleeved on the solid block, and an upper end of the solid block protrudes into the telescopic groove; the right end surface of the solid block is a sloped structure for abutting with the annular plate.

7. The protective glass cutting machine according to claim 1, wherein said output means comprises a moving chamber; a driving motor is fixed in a right end wall of the moving chamber, a rotating screw is mounted on a left end of the driving motor, a left end of the rotating screw is rotatably connected to a left end wall of the moving cavity, and a moving block is slid in the moving cavity. a lower end surface of the moving block is a toothed structure, and a front end of the moving block and a front end wall of the moving cavity are fixed with a connecting spring; a sliding slot is disposed in the moving block, and a sliding block is slidably disposed in the sliding slot, the sliding block is screwed to the rotating screw, and a winding chamber is disposed on an upper side of the sliding slot. a winding wheel is disposed in the cavity, and two pulling ropes are fixedly arranged on the winding wheel, and the pulling rope is arranged in front and rear; the upper end wall of the winding chamber is fixed with a rotating motor, and the winding wheel is dynamically connected with the rotating motor.

8. The protective glass cutting machine according to claim 7, wherein the moving block is provided with a front and rear symmetrical clamping cavity; the clamping cavity is in communication with the output cavity, and a tensioning wheel is disposed between the clamping cavity and the winding cavity, and the lower end of the cable extends around the tensioning wheel and extends into the a clamping slide is slid in the clamping cavity, and the pulling rope is fixedly connected to the clamping sliding rod; a clamping spring is fixed to an end surface of the clamping slide away from the output cavity, and a clamping block is fixed to an end of the clamping sliding bar near the center of the symmetry, and the clamping block is close to a symmetric center. Anti-slip mats are fixed on the end faces.

9. The protective glass cutting machine according to claim 1, wherein said vibration device comprises a transmission groove; the upper side of the transmission slot is in communication with the moving cavity, the transmission slot is internally provided with a transmission gear, the transmission gear meshes with the moving block, and a transmission shaft is fixed at a center of the transmission gear; a rearward side of the transmission slot is provided with a reversing cavity, a rear end of the transmission shaft extends into the reversing cavity and a fifth bevel gear is fixed, and a rear end of the fifth bevel gear is meshed with a sixth cone a gear, a reversing shaft is fixed at a center of the sixth bevel gear; a cam cavity is disposed on the upper side of the reversing cavity, and an upper end of the reversing rotating shaft is rotatably connected to an upper end wall of the cam cavity, and a cam is fixed on the reversing rotating shaft in the cam cavity, the cam Abutting against the rear end surface of the moving block.
